(19) United States
(12) Patent Application Publication
(10) Pub. No.: US 2018/0320530 A1
(43) Pub. Date: Nov. 8, 2018

(54) AIRFOIL WITH TIP RAIL COOLING

(71) Applicant: General Electric Company, Schenectady, NY (US)

(72) Inventors: Kevin Robert Feldmann, Mason, OH (US); Robert Charles Groves, II, West Chester, OH (US); Weston Nolan Dooley, West Chester, OH (US); James Michael Hoffman, Hamilton Township, OH (US)

(21) Appl. No.: 15/587,974

(22) Filed: May 5, 2017

(51) Int. Cl. F01D 5/18; F01D 5/14

(52) U.S. Cl. CPC F01D 5/186; F01D 5/141; F05D 2220/323; F05D 2260/202; F05D 2240/307

(57) ABSTRACT

An apparatus and method for cooling an airfoil tip for a turbine engine can include an airfoil, such as a cooled turbine blade, having a tip rail extending beyond a tip wall enclosing an interior for the airfoil at the tip. A plurality of cooling holes can be provided in the tip rail. A flow of cooling fluid can be provided through the cooling holes from the interior of the airfoil to cool the tip of the airfoil.

### BACKGROUND OF THE INVENTION

Turbine engines, and particularly gas or combustion turbine engines, are rotary engines that extract energy from a flow of combusted gases passing through the engine onto a multitude of rotating turbine blades, and in some cases, such as aircraft, generate thrust for propulsion.

Gas turbine engines for aircraft are designed to operate at high temperatures to maximize engine efficiency, so cooling of certain engine components, such as a high pressure turbine and a low pressure turbine, can be beneficial. Typically, cooling is accomplished by ducting cooler air from high and/or low pressure compressors to the engine components that require cooling. Temperatures in the high pressure turbine can be 1000° C. to 2000° C. and the cooling air from the compressor can be 500° C. to 700° C., enough of a difference to cool the high pressure turbine.

Contemporary turbine blades, as well as vanes or nozzles, generally include one or more interior cooling circuits for routing the cooling air through the blade to cool different portions of the blade, and can include dedicated cooling circuits for cooling different portions of the blade, such as the leading edge, trailing edge and tip of the blade.

### BRIEF DESCRIPTION OF THE INVENTION

In one aspect, the disclosure relates to a blade for a turbine engine including an outer wall bounding an interior and having a pressure side and a suction side extending axially between a leading edge and a trailing edge defining a chord-wise direction and extending radially between a root and a tip defining a span-wise direction. A cooling circuit is located in the interior and has at least one cooling passages. A tip wall encloses the interior at the tip. A tip rail extends from the outer wall beyond the tip wall having an exterior surface and an interior surface. A plurality of cooling holes are provided in the tip rail fluidly coupled to the cooling passage, each of the plurality of cooling holes including an outlet positioned along the exterior surface.

In another aspect, the disclosure relates to an airfoil for a turbine engine including an outer wall bounding an interior and having a pressure side and a suction side extending axially between a leading edge and a trailing edge defining a chord-wise direction and extending radially between a root and a tip defining a span-wise direction. A tip rail extends from the outer wall at the tip and has an exterior surface. A plurality of cooling holes are provided in the tip rail coupled to the interior, each of the plurality of cooling holes having an outlet on the exterior surface and spaced about the tip rail.

In yet another aspect, the disclosure relates to a method of cooling a tip of an airfoil for a turbine engine including exhausting a cooling fluid through a plurality of cooling holes provided within a tip rail formed at the tip of the airfoil with outlets provided at an exterior surface of the tip rail.

### BRIEF DESCRIPTION OF THE DRAWINGS

In the drawings:

FIG. 1 is a schematic cross-sectional diagram of a portion of a turbine engine for an aircraft.

FIG. 2 is a perspective view of an airfoil of the engine of FIG. 1 including a tip with a plurality of cooling holes.

FIG. 3 is section view of the airfoil of FIG. 2 taken across section 3-3 illustrating cooling passages within the airfoil.

FIG. 4 is an isometric view of the tip and pressure side of the airfoil of FIG. 2 illustrating the plurality of cooling holes fluidly coupled to the cooling passages of FIG. 3.

FIG. 5 is an isometric view of the tip and suction side of the airfoil of FIG. 4.

FIG. 6 is an isometric view of a tip for an alternative airfoil including a tip shelf and a tip slot, with a leading edge portion absent cooling holes along the tip rail.

FIG. 7 is an isometric view of a tip of another alternative airfoil including a winglet at least partially forming the tip.

### DETAILED DESCRIPTION OF THE INVENTION

Aspects of the disclosure described herein are directed to a tip rail including a plurality of cooling holes having outlets formed in the tip rail extending around the tip of an airfoil. For purposes of illustration, the present disclosure will be described with respect to a blade for a turbine in an aircraft gas turbine engine. It will be understood, however, that aspects of the disclosure described herein are not so limited and may have general applicability within an engine, including compressors, as well as in non-aircraft applications, such as other mobile applications and non-mobile industrial, commercial, and residential applications.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component.

Additionally, as used herein, the terms “radial” or “radially” refer to a dimension extending between a center longitudinal axis of the engine and an outer engine circumference. A “set” as used herein can include any number of a particular element, including only one.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

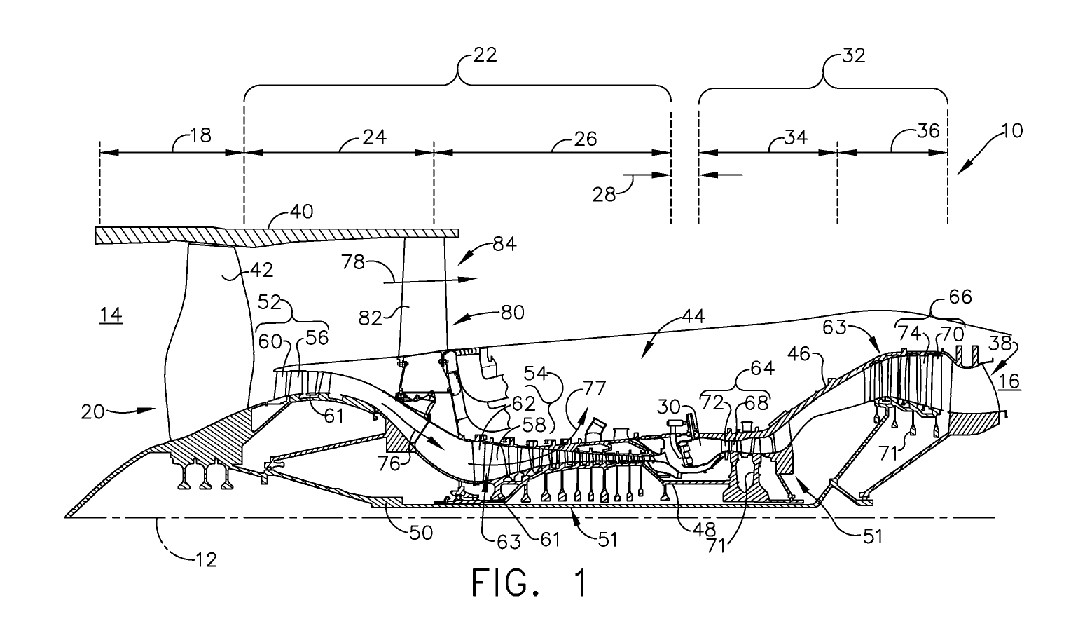

FIG. 1 is a schematic cross-sectional diagram of a portion of a gas turbine engine 10 for an aircraft. The engine 10 has a longitudinally extending axis or centerline 12 extending from forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12 and rotatable within the fan casing 40. The HP compressor 26, the combustor 30, and the HP turbine 34 form a core 44 of the engine 10, which generates and extracts energy from combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor can be mounted to a disk 61, which is mounted to one of the corresponding HP and LP spools 48, 50, with each stage having its own disk 61. The vanes 60, 62 for a stage of the compressor can be mounted to the core casing 46 in a circumferential arrangement.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can be mounted to a disk 71, which is mounted to one of the corresponding HP and LP spools 48, 50, with each stage having a dedicated disk 71. The vanes 72, 74 for a stage of the compressor can be mounted to the core casing 46 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow exiting the fan section 18 is split such that a portion of the airflow is channeled into the LP compressor 24, which then supplies pressurized air 76 to the HP compressor 26, which further pressurizes the air. The pressurized air 76 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and are ultimately discharged from the engine 10 via the exhaust section 38. The driving of the LP turbine 36 drives the LP spool 50 to rotate the fan 20 and the LP compressor 24.

A portion of pressurized airflow 76 generated in the compressor section 22 can be drawn from the compressor section 22 as bleed air 77. The bleed air 77 can be drawn from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of airflow 78 from the fan section 18 bypasses the LP compressor 24 and engine core 44 and exits the engine assembly 10 through a stationary vane row, and more particularly an outlet guide vane assembly 80, comprising a plurality of airfoil guide vanes 82, at a fan exhaust side 84. More specifically, a circumferential row of radially extending airfoil guide vanes 82 is utilized adjacent the fan section 18 to exert some directional control of the airflow 78.

The airflow 78 can be a cooling fluid used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

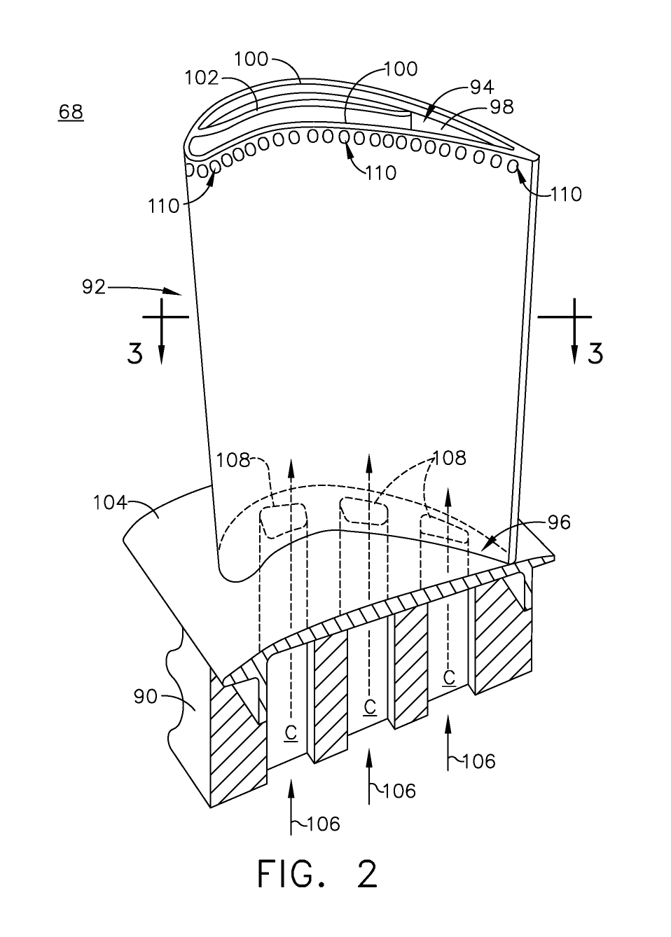

Referring to FIG. 2, an engine component in the form of one of the turbine blades 68 includes a dovetail 90 and an airfoil 92. The airfoil 92 includes a tip 94 and a root 96 defining a span-wise direction therebetween. A tip wall 98 is provided at the tip 94, with a tip rail 100 extending from the tip wall 98. An optional tip baffle 102 is shown at the tip 94 and extends from the tip rail 100 along the tip wall 98. A plurality of cooling holes 110 are provided in the tip rail 100. The cooling holes 110 can be local bore cooling holes, in one non-limiting example, that are drilled into the tip rail 100.

The airfoil 92 mounts to the dovetail 90 by way of a platform 104 at the root 96. The platform 104 helps to radially contain a turbine engine mainstream airflow driven by the blade 68. The dovetail 90 can be configured to mount to a turbine rotor disk on the engine 10 to drive the blade 68. The dovetail 90 further includes at least one inlet passage 106, with the exemplary dovetail 90 shown as a having three inlet passages 106. The inlet passages 106 extend through the dovetail 90 and the platform 104 to provide internal fluid communication with the airfoil 92 at corresponding passage outlets 108. It should be appreciated that the dovetail 90 is shown in cross-section, such that the inlet passages 106 are enclosed within the body of the dovetail 90. A flow of cooling fluid C, such as airflow 77 and/or airflow 78 can be provided to the airfoil 92 through the inlet passage 106 exhausting at the outlets 108.

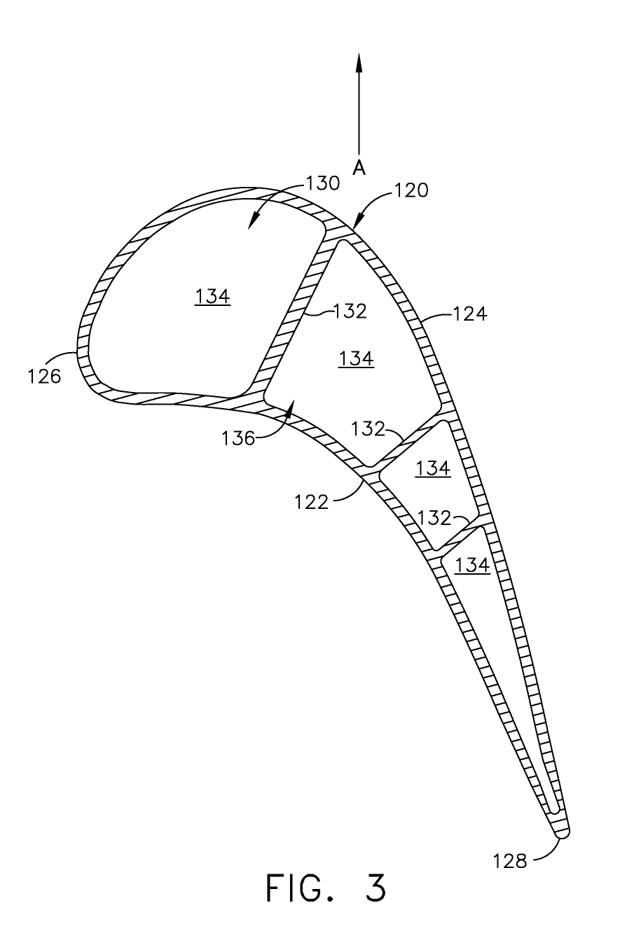

Referring now to FIG. 3, the airfoil 92 includes an outer wall 120 with a concave-shaped pressure sidewall 122 and a convex-shaped suction sidewall 124 joined together to define the airfoil shape for the airfoil 92, and includes a leading edge 126 and a trailing edge 128 defining a chord-wise direction therebetween. During operation, the airfoil 92 rotates in a direction A such that the pressure sidewall 122 follows the suction sidewall 124. Thus, as shown in FIG. 3, the airfoil 92 would rotate upward toward the top of the page.

An interior 130 is defined by the outer wall 120. One or more interior walls shown as ribs 132 can divide the interior 130 into multiple cooling passages 134. The cooling passages 134 can fluidly couple to one or more other cooling passages 134 or features formed within the airfoil 92 to define one or more cooling circuits 136. It should be appreciated that the interior structure of the airfoil 92 is exemplary as illustrated. The interior 130 of the airfoil 92 can be organized in a myriad of different ways, and the cooling passages 134 can include single passages extending in the span-wise direction, or can be complex cooling circuits, having multiple features such as passages, channels, inlets, outlets, ribs, pin banks, circuits, sub-circuits, film holes, plenums, mesh, turbulators, or otherwise in non-limiting examples. Preferably, the cooling passages 134 will be in fluid communication with the inlet passages 106.

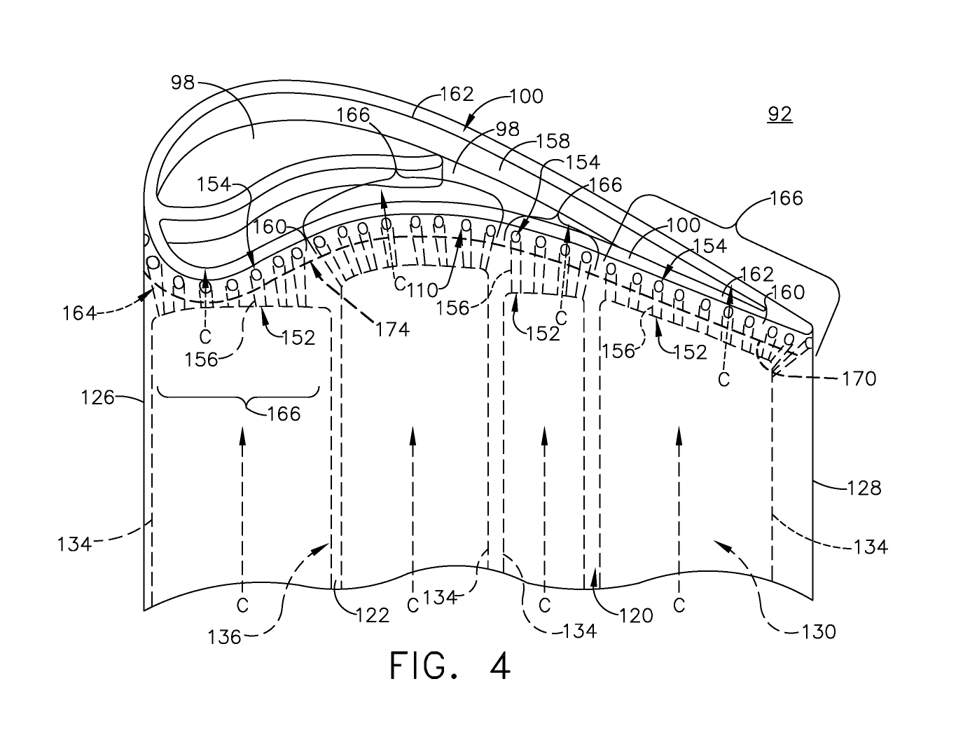

Referring now to FIG. 4, the tip wall 98 encloses the interior 130 of the airfoil 92. The tip wall 98 can be substantially flat, while contouring of the tip wall 98 is contemplated. The tip wall 98 can extend substantially orthogonal to the adjacent outer wall 120. Additionally, the tip wall 98 can at least partially form one or more of the cooling passages 134, as well as the cooling circuit 136.

The plurality of cooling holes 110 can each include an inlet 152 and an outlet 154, defining a passage 156 therebetween. While each cooling hole 110 is shown as having an inlet 152 and an outlet 154, it is contemplated that the cooling holes 110 can share inlets 152 or outlets 154 as is desirable based upon flow rates and requirements of the particular airfoil 92. The outlets 154 can be positioned at the cooling passages 134, fluidly coupling the cooling holes 110 to the cooling passages 134 and the cooling circuit 136. The outlets 154 are arranged on the tip rail 100. One of more passages 156 can further include a diffusion section 164 adjacent the outlet 154, having an increasing cross-sectional area extending toward the outlet 154. The diffusion section 164 can provide for decreasing the exhausting velocity of a cooling fluid C and spreading the exhausted cooling fluid C over a greater surface area, exterior of the airfoil 92.

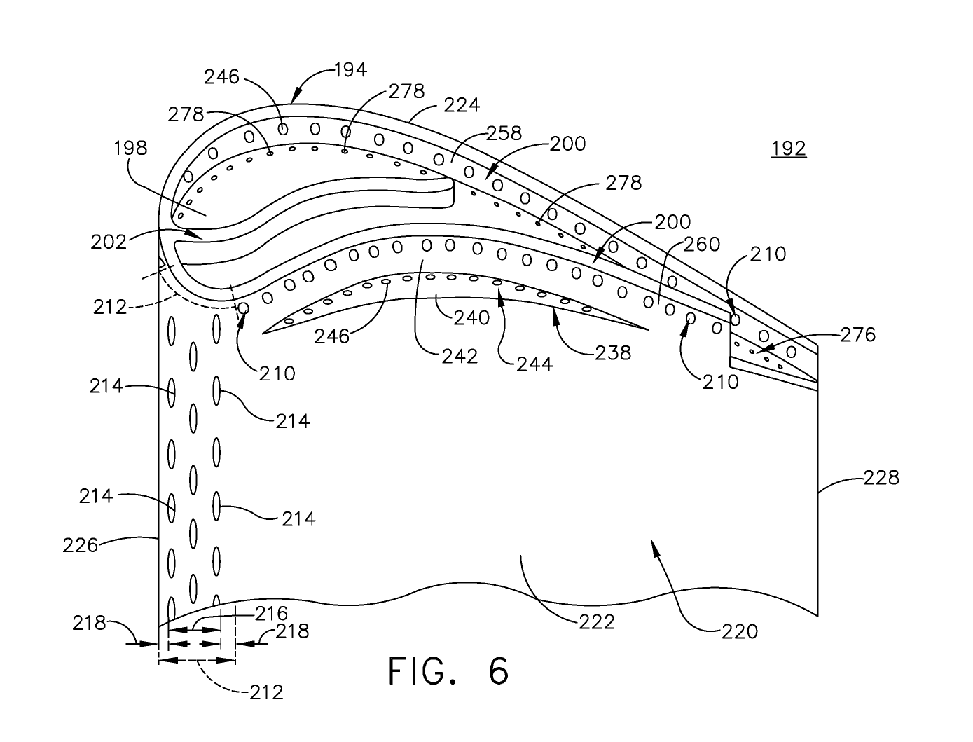

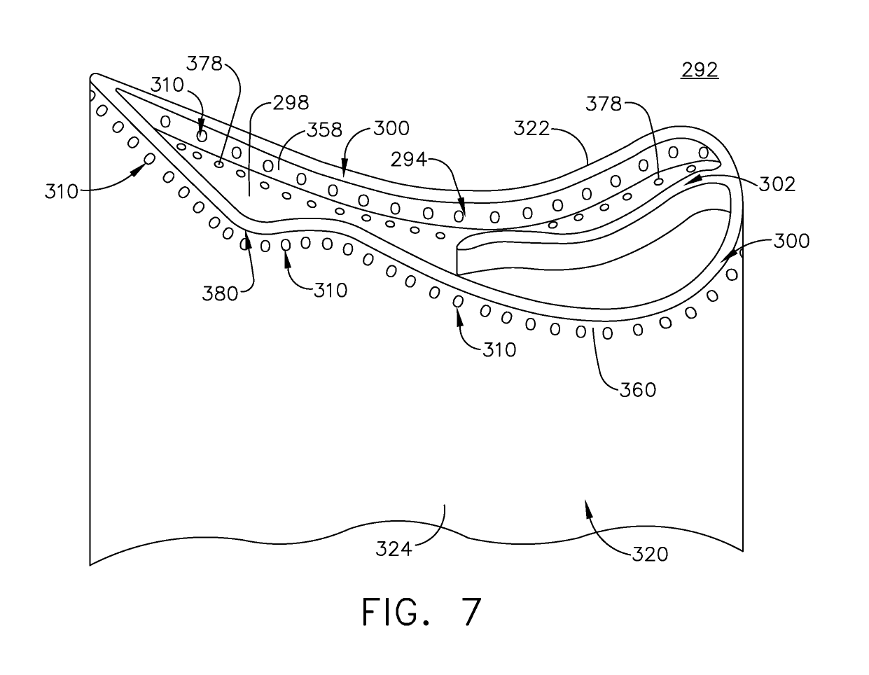

The tip rail 100 can further include an interior surface 158 adjacent the tip wall 98 and an exterior surface 160 extending from the outer wall 120 above the tip wall 98, with a top surface 162 connecting the interior surface 158 to the exterior surface 160. Optionally, the interior surface 158 can include a fillet, providing improved structural integrity for the tip rail and additional room in forming the cooling holes 110. The outlets 154 can be positioned on the exterior surface 160 of the tip rail 100. Alternatively, it is contemplated that the outlets 154 can be positioned on the interior surface 158, as is best illustrated in FIGS. 6 and 7 and discussed in detail below. The outlets 154 can be spaced from the top surface 162 to prevent closing of the cooling holes 110 during a rub event, whereby the airfoil 92 as the exemplary rotating blade can contact a radially outer shroud.

The plurality of cooling holes 110 can be separated into sets 166. Each set can couple to a dedicated cooling passage 134. The organization of sets 166 of cooling holes 110 can be adapted to evenly supply a cooling fluid C to all cooling holes 110. For example, a smaller cooling passage 134, supporting a lesser flow rate, can have a lesser number of dedicated cooling holes 110, while a larger cooling passage 134 can support a greater flow rate providing fluid to a greater number of cooling holes 110. Alternatively, the cooling holes 110 can be adapted to provide the cooling fluid C to areas where there may be a greater need for cooling fluid, such as toward the trailing edge where fluid separation may occur during operation.

The tip rail 100 along the pressure sidewall 122 can define a pressure-side distance 170, measured between the leading edge 126 and the trailing edge 128, while following the curvature of the airfoil 92 and the pressure sidewall 122. In one example, the plurality of cooling holes 110 can cover at least 25% of the pressure-side distance 170. Cover or covering as used herein should be understood to mean that the cross-sectional length of the cooling holes 110 along the pressure sidewall 122 can occupy a portion or percentage of the total length of the pressure side distance 170. In the example of at least 25%, covering 25% can be calculated by multiplying the number of cooling holes 110 by the diameter of the cooling holes 110 at the outlet 154, then dividing the total by the pressure side distance 170, resulting in a value that can be at least 0.25. In another example, the plurality of cooling holes 110 can cover at least 50% of the pressure-side distance 170.

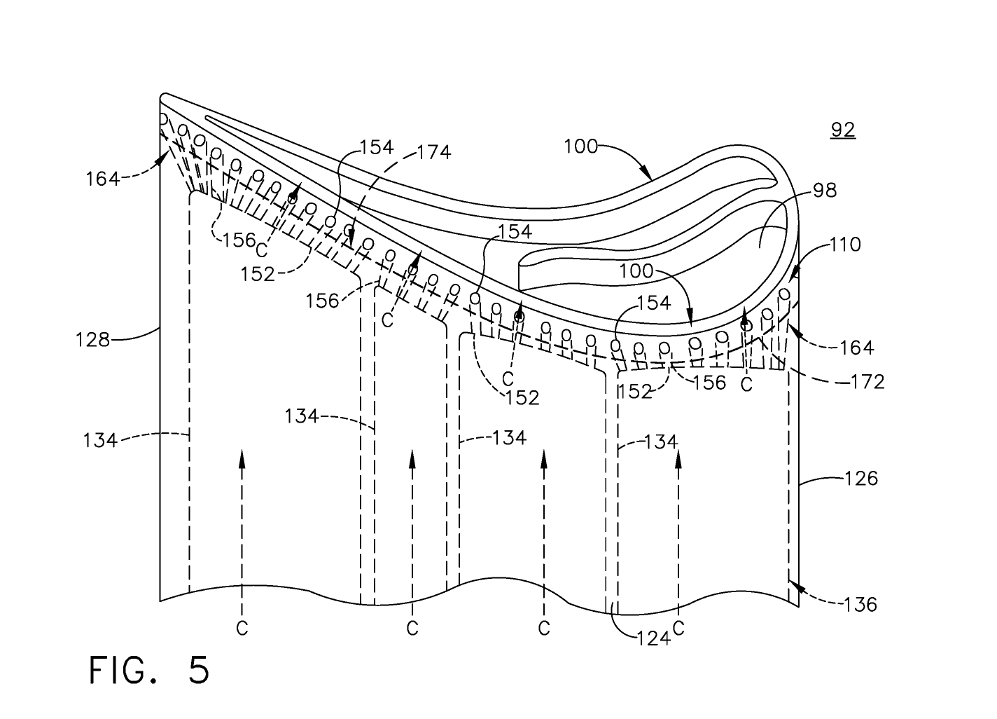

Referring now to FIG. 5, the suction sidewall 124 can define a suction-side distance 172, measured between the leading edge 126 and the trailing edge 128, while following the curvature of the suction sidewall 124. In one example, the plurality of cooling holes 110 can cover at least 25% of the suction-side distance 172. In another example, the plurality of cooling holes 110 can cover at least 50% of the suction-side distance 172.

When combining the pressure-side distance 170 of FIG. 4 and the suction-side distance 172 of FIG. 5, a tip rail distance 174 can be defined around the entire perimeter of the tip rail 100. The plurality of cooling holes 110 can cover at least 25% of the chord-wise length of the tip rail 100 as the tip rail distance 174, and, alternatively, at least 50% of the chord-wise length of the tip rail 100 as the tip rail distance 174.

In operation, a flow of fluid C can pass through the cooling passages 134, the cooling circuit 136, or both, feeding the plurality of cooling holes 110 at their respective inlets 152. The flow of fluid C can diffuse through the diffusion section 164 within the passages 156 and exhaust from the airfoil 92 through the outlets 154 along the tip rail 100. The diffusion section 164 promotes improved cooling film coverage and thus, effectiveness. The exhausted flow of fluid C can form a cooling film along the tip rail 100. The exhausted flow of fluid C can wash over the tip rail 100 to additionally cool the tip 94 at the tip wall 98.

The airfoil as described herein includes the tip rail 100 defining a tip perimeter that is encircled by cooling holes 110 to improve local cooling effectiveness. The design provides for improved cooling of the blade tip with improved local film cooling along the exterior of the tip rail 100. The plurality of cooling holes 110 provides for larger cooling film with greater cooling effectiveness than prior designs which relied on a cooling film spilling over the tip rails from the interior of the tip along the tip wall. The improved design provides for improved tip durability and longer part life.

In typical blade tip designs, the cooling holes are provided on the tip wall, adjacent the tip rail along the suction side. The flow of cooling fluid C is provided through the holes in the tip wall and is permitted to flow over the tip rails to sufficiently cool the tip of the airfoil. However, this method of cooling the tip is susceptible to non-uniform flow patterns and fails to effectively cool the tip. The tip 94 as described herein utilizing the plurality of cooling holes 110 organized along the exterior of the tip rail 100 uniformly cools the tip without requiring the flow to spill over the tip rail.

FIG. 6 shows an alternative exemplary airfoil 192, which can be substantially similar to the airfoil of FIGS. 2-5. As such, similar elements will be described with similar numerals, increased by a value of one hundred, and the discussion will be limited to differences between the two. The airfoil 192 can include a tip rail 200 including a leading edge portion 212. A showerhead arrangement of film holes 214 can be provided along an outer wall 220 extending along a leading edge 226 of the airfoil 192. A chord-wise extent 216 of the film holes 214 along the leading edge 226 can at least partially define the chord-wise length leading edge portion 212 along the tip rail 200. The leading edge portion 226, for example, can encompass the chord-wise length of the film holes 214, as well as two widths 218 of the film holes 214 extending on either side of the chord-wise extent 216 of the film holes 214, transposed along the tip rail 200 at the leading edge 226.

It should be appreciated that the leading edge portion 212 can be absent a plurality of cooling holes 210 arranged about the tip rail 200. Cooling holes may be absent along the leading edge portion 212 as the film holes 214 near the leading edge 226 can provide sufficient cooling to the tip rail 200 at the leading edge 226 within the leading edge portion 212. However, it should be appreciated that the leading edge portion 212 can include cooling holes 210 in combination with the film holes 214 along the leading edge 226 based upon the needs of the particular airfoil or implementation thereof.

The cooling holes 210 can alternatively be positioned having the outlet 246 formed an interior surface 258 of the tip rail 200. Furthermore, it is contemplated that the cooling holes 210 can have outlets 246 on a combination of the interior surface 258 and the exterior surface 260. In such an example, the cooling holes 210 coverage of the tip rail 200 can be calculated as a combination of both the interior and exterior surface 258, 260 of the tip rail 200. In one non-limiting example, the cooling holes 210 on the pressure sidewall 222 can be positioned on the exterior surface 260, while the cooling holes 210 on the suction sidewall 224 can be positioned on the interior surface 258. In another non-limiting example, the cooling holes 210 can be positioned in an alternating pattern, with alternating cooling holes 210 on the interior and exterior surfaces 258, 260.

Additionally, the airfoil 192 can include an optional tip shelf 238 provided in a pressure sidewall 222 of the outer wall 220. The tip shelf 238 can be formed as a negative feature extending into the pressure-sidewall 222, defining a shelf 240 and a recessed sidewall 242. One or more tip shelf cooling holes 244 can have outlets 246 provided in the shelf 240. Alternatively, it is contemplated that the outlets 246 can be provided in the recessed wall 242, or a combination of the recessed wall 242 and the shelf 240. The tip shelf cooling holes 244 can be used to enhance to cooling fluid flow provided below the cooling holes 210 in the tip rail 200.

A tip slot 276 can be formed in the tip 194 adjacent a trailing edge 228. The tip slot 276 can be a gap formed in the tip rail 200. The tip slot 276 can provide another area absent of the plurality of cooling holes 210, as the tip rail 200 is absent within the tip slot 276.

A set of tip wall cooling holes 278 can be provided in a tip wall 198. The tip wall cooling holes 278 can be arranged along the tip wall 198 spaced from the tip rail 200 provided along a suction sidewall 224. The tip wall cooling holes 278 can provide for enhancing a cooling flow provided from the cooling holes 210 provided along the tip rail 200 at the suction sidewall 224. In operation, at least a portion of the cooling flow provided form the tip wall cooling holes 278 can wash over tip rail 200 at the suction sidewall 224 enhancing the cooling flow provided from the cooling holes 210.

While the airfoil 192 of FIG. 6 is illustrated as having the leading edge portion 212 absent the cooling holes 210, the tip shelf 238, the tip slot 276, and the tip wall cooling holes 278, it should be understood that the airfoil as shown is exemplary, and need not include all of the aforementioned. An airfoil including the cooling holes 210 can have one or more of the leading edge portion 212, the tip shelf 238, the tip slot 276, and the tip wall cooling holes 278 in any combination as is desirable to the particular airfoil. Such features can be tailored to balance cooling needs with engine efficiency.

FIG. 7 shows another alternative exemplary airfoil 292, which can be substantially similar to the airfoil of FIGS. 2-5. As such, similar elements will be described with similar numerals, increased by a value of two hundred, and the discussion will be limited to differences between them. The airfoil 292 can include a winglet 380 extending from a suction sidewall 324 of the outer wall 320. The winglet 380 is an extension of additional material that varies from the traditional airfoil shape. While the winglet 380 is illustrated on the suction sidewall 324, it should be appreciated that the winglet can be provided anywhere along the airfoil outer wall 320 at a tip 294 of the airfoil 292, such as along the pressure sidewall 322, or a combination of the pressure sidewall 322 and the suction sidewall 324. The tip rail 300 can be arranged complementary to the winglet 380, following the modified airfoil shape resultant of the winglet 380. A plurality of cooling holes 310 provided on the tip rail can also be formed on the winglet 380.

Additionally, the cooling holes 310 can be positioned on the interior surface 358 of the tip rail 300 along the pressure sidewall 322. As such, the airfoil 292, or any airfoil as described herein, can include cooling holes 310 positioned along both the interior and exterior 358, 360 of the tip rail 300 as is desirable for the particular airfoil or implementation thereof.

The winglet 380 can provide for influencing airflows at the exterior of the airfoil 292 along the tip 294 to improve efficiency. The cooling holes 310 provided in the tip rail 300 provide for cooling the winglet 380, which can be susceptible to heightened operational temperatures or local gathering of heat.

A set of tip wall cooling holes 378 can be provided along the tip wall 298. The set of tip wall cooling holes 378 can be spaced from the tip rail 300 arranged along the pressure sidewall 322. Alternatively, the set of tip wall cooling holes 378 can be arranged in the tip wall 298 spaced from the tip rail 300 along both the pressure sidewall 322 and the suction sidewall 324, or spaced from a tip baffle 302, or any combination thereof in non-limiting examples.

To the extent not already described, the different features and structures of the various embodiments can be used in combination with each other as desired. That one feature is not illustrated in all of the embodiments is not meant to be construed that it cannot be, but is done for brevity of description. For example, the cooling holes as described herein can be positioned anywhere as described herein or shown. For example, the cooling holes can be positioned on the interior or exterior of the tip rail, or in any combination thereof. Furthermore, the cooling holes in the tip rail can be formed in combination with any additional cooling features as described herein, in any combination. Such features include, the tip baffle, which may or may not include the tip shelf with cooling holes in any position, the tip slot, the leading edge portion absent cooling holes, or the winglet. Thus, the various features of the different embodiments can be mixed and matched as desired to form new embodiments, whether or not the new embodiments are expressly described. All combinations or permutations of features described herein are covered by this disclosure.

A method of cooling a tip of an airfoil for a turbine engine can including exhausting a cooling fluid through a plurality of cooling holes provided in a tip rail formed at the tip of the airfoil with outlets provided at an exterior or interior surface of the tip rail. The tip rail can be the tip rail 100, 200, 300 as described herein, for example, including the cooling holes 110, 210, 310 formed therein. A flow of fluid can be provided to the cooling holes to exhaust from the airfoil. The flow of fluid can be a cooling fluid provided to the airfoil that, when exhausted, operates to cool the tip of the airfoil. In one example, the exhausted fluid can provide film cooling along portions of the tip of the airfoil.

The method can further include diffusing the cooling fluid through a diffusion section of the cooling holes adjacent the outlet, such as the diffusion section 164 as described herein. Diffusing the cooling fluid as it exhausts from the cooling holes provides for a greater area of coverage for the cooling fluid along the exterior or interior of the airfoil, particularly as a cooling film.

The method as described provides for improved cooling for a tip of an airfoil, providing cooling to a tip while operating under constantly increasing engine temperatures required to meet increasing efficiency requirements for turbine engines. Improved cooling can withstand increased operational temperatures, as well as increase component lifetime and reduce required maintenance of the component.

It should be appreciated that application of the disclosed design is not limited to turbine engines with fan and booster sections, but is applicable to turbojets and turbo engines as well.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A blade for a turbine engine comprising:
an outer wall bounding an interior and having a pressure side and a suction side extending axially between a leading edge and a trailing edge defining a chord-wise direction and extending radially between a root and a tip defining a span-wise direction;
at least one cooling passage formed in the interior;
a tip wall enclosing the interior at the tip;
a tip rail extending from the outer wall beyond the tip wall having an exterior surface and an interior surface; and
a plurality of cooling holes provided in the tip rail fluidly coupled to the cooling passage, each of the plurality of cooling holes including an outlet positioned along the exterior surface or the interior surface.

2. The blade of claim 1 wherein the tip rail further includes a leading edge portion spaced relative to the leading edge and some of the plurality of cooling holes are absent in the leading edge portion.

3. The blade of claim 1 wherein the plurality of cooling holes is arranged to cover at least 25% of a chord-wise length of the tip rail.

4. The blade of claim 3 wherein the plurality of cooling holes is arranged to cover at least 50% of the chord-wise length of the tip rail.

5. The blade of claim 1 wherein at least some of the plurality of cooling holes are shaped with a diffusion section adjacent the outlet.

6. The blade of claim 1 wherein the tip wall partially defines the at least one cooling passage.

7. The blade of claim 1 further comprising a tip baffle provided along the tip wall extending from the tip rail.

8. The blade of claim 1 further comprising a tip shelf formed along a portion of the pressure side of the outer wall.

9. The blade of claim 8 further comprising a set of tip shelf cooling holes with outlets provided on the tip shelf and fluidly coupled to the at least one cooling passage.

10. The blade of claim 1 further comprising a set of tip wall cooling holes provided in the tip wall and fluidly coupled to the at least one cooling passage.

11. The blade of claim 1 further comprising a tip slot formed in a portion of the tip rail adjacent the trailing edge.

12. The blade of claim 1 further comprising a winglet formed on the suction side and wherein the tip rail is formed complementary to the winglet.

13. An airfoil for a turbine engine, the airfoil comprising:
an outer wall bounding an interior and having a pressure side and a suction side extending axially between a leading edge and a trailing edge defining a chord-wise direction and extending radially between a root and a tip defining a span-wise direction;
a tip rail extending from the outer wall at the tip; and
a plurality of cooling holes provided in the tip rail fluidly coupled to the interior, each of the plurality of cooling holes having an outlet spaced about the tip rail.

14. The airfoil of claim 13 wherein the tip rail further includes a leading edge portion spaced relative to the leading edge and some of the plurality of cooling holes are absent in the leading edge portion.

15. The airfoil of claim 13 wherein the plurality of cooling holes is arranged to cover at least 25% of a chord-wise length of the tip rail.

16. The airfoil of claim 13 wherein the plurality of cooling holes is arranged to cover at least 50% of the chord-wise length of the tip rail.

17. The airfoil of claim 13 further comprising a tip shelf formed along a portion of the pressure side of the outer wall.

18. The airfoil of claim 17 further comprising a set of tip shelf cooling holes with outlets provided on the tip shelf and fluidly coupled to the interior.

19. A method of cooling a tip of an airfoil for a turbine engine, the method comprising:
exhausting a cooling fluid through a plurality of cooling holes provided in a tip rail formed at the tip of the airfoil with outlets provided at an exterior surface or an interior surface of the tip rail.

20. The method of claim 19 further comprising diffusing the cooling fluid through a diffusion section of each of the plurality of cooling holes adjacent the outlets.
